(19) United States
(12) Patent Application Publication
(10) Pub. No.: US 2010/0075189 A1
(43) Pub. Date: Mar. 25, 2010

(54) CURRENT COLLECTOR AND FUEL CELL STACK

(75) Inventors: Hye-Yeon Cha, Yongin-si (KR); Young-Soo Oh, Seongnam-si (KR); Jae-Hyuk Jang, Seoul (KR); Sung-Ham Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/564,414

(22) Filed: Sep. 22, 2009

(30) Foreign Application Priority Data
Sep. 22, 2008 (KR) 10-2008-0092574

(51) Int. Cl. H01M 8/10; H01M 8/02

(52) U.S. Cl. 429/30; 429/12

(57) ABSTRACT

A current collector and a fuel cell stack are disclosed. The current collector in accordance with an embodiment of the present invention includes: a substrate; a double-side adhesive layer, which is formed on one surface of the substrate; a collecting pattern, which is formed on the other surface of the substrate; and a conductive adhesive layer, which is formed on the collecting pattern. While using the current collector described above, electrical resistance in a fuel cell can be reduced, thus improving the performance of the fuel cell. Moreover, even if the thickness of an endplate is thin, clamping pressure required in the fuel cell can be provided.

### CROSS-REFERENCE TO RELATED APPLICATIONS

This application claims the benefit of Korean Patent Application No. 10-2008-0092574, filed with the Korean Intellectual Property Office on Sep. 22, 2008, the disclosure of which is incorporated herein by reference in its entirety.

### BACKGROUND

1. Technical Field

The present invention relates to a current collector and a fuel cell stack.

2. Description of the Related Art

There has been an increasing demand for a power source that has a higher energy density than that of a lithium-ion battery since mobile devices have a higher power consumption due to the increased number of functions, such as digital multimedia broadcasting (DMB) and GPS navigation.

A fuel cell is being developed for use in power generation, automobiles, home appliances, mobile devices and many other applications, and a small fuel cell is being used as an alternative for lithium-ion batteries used in consumer electronic devices, such as mobile phones, PDAs and laptop computers. Nevertheless, commercialization of a mobile fuel cell still is a way off unless the problem of efficiency is resolved, as it is required that the mobile fuel cell be small but generate adequate power.

The fuel cell power generation system basically includes a fuel cell stack, in which a number of unit cells for generating electricity are stacked. The stack is basically structured in such a way that a plurality of unit cells stacked between end plates are fastened together bolts and nuts. The unit cell has a membrane electrode assembly (MEA), in which a fuel electrode and an air electrode are attached to either side of an electrolyte membrane, and separators, i.e., bipolar plates, which are positioned on either side of the membrane electrode assembly and in which fluid channels are formed.

A current collector can be positioned inside the end plates to collect electric currents. A metal mesh made of nickel (Ni) is mainly used as the current collector, but the performance of the fuel cell is often deteriorated due to the oxidation of the metal. Moreover, if the fuel cell current collector is not in contact with a gas diffusion layer, it may cause a rapid increase in resistance, thus lowering the overall performance of the fuel cell.

For this reason, a flexible current collector, in which a copper wiring is formed on a polyimide film, has been often used recently. This kind of current collector is positioned between the gas diffusion layer of an MEA and an end plate at which a fuel channel is located and collects electric currents transferred from the gas diffusion layer to transfer the electric currents to a place that needs the electric currents.

FIG. 1 is a graph illustrating the magnitude of electrical resistance while electrons are formed and transferred in a fuel cell. The graph compares R_{D}, which is the resistance value when the electrons pass through the gas diffusion layer, R_{Gr}, which is the resistance value when the electrons pass through the current collector, and R_{D}/R_{Gr}, which is the resistance value when the electrons are at a boundary surface between the gas diffusion layer and the current collector. The graph shows that the resistance value R_{D}/R_{Gr} measured at the boundary surface between the gas diffusion layer and the current collector is the greatest. This electrical resistance represents the energy loss of the fuel cell.

As one of the methods for reducing the electrical resistance at this boundary surface, the clamping pressure is increased, often by increasing the thickness of the endplate of the fuel cell. This, however, dramatically increases the volume and weight of the fuel cell, making it difficult to miniaturize the fuel cell.

### SUMMARY

The present invention provides a current collector and a fuel cell stack that can reduce electrical resistance in a fuel cell while reducing the size of the fuel cell.

An aspect of the present invention provides a current collector. The current collector in accordance with an embodiment of the present invention includes: a substrate; a double-side adhesive layer, which is formed on one surface of the substrate; a collecting pattern, which is formed on the other surface of the substrate; and a conductive adhesive layer, which is formed on the collecting pattern.

An aperture through which gas can pass can be formed on the substrate, and the collecting pattern can be made of a material comprising at least one selected from a group consisting of copper (Cu), nickel (Ni), gold (Au) and platinum (Pt). Here, the substrate can be a flexible film.

Another aspect of the present invention provides a fuel cell stack. The fuel cell stack in accordance with an embodiment of the present invention includes: a pair of end plates; a current collector, in which one surface of the current collector is in contact with an inner side of the pair of end plates; and a membrane electrode assembly (MEA), which is interposed between the current collectors and includes an electrolyte layer, an air electrode and a fuel electrode and in which the air electrode and the fuel electrode are coupled to either surface of the electrolyte layer, in which the current collector includes: a substrate; a double-side adhesive layer, which is formed on one surface of the substrate and is in contact with the end plate; a collecting pattern, which is formed on the other surface of the substrate; and a conductive adhesive layer, which is formed on the collecting pattern and is in contact with the membrane electrode assembly.

An aperture through which gas can pass can be formed on the substrate, and the collecting pattern can be made of a material comprising at least one selected from a group consisting of copper (Cu), nickel (Ni), gold (Au) and platinum (Pt). Here, the substrate can be a flexible film.

There can be a plurality of membrane electrode assemblies, and a bipolar plate can be interposed and stacked between the plurality of membrane electrode assemblies.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a graph comparing the magnitude of electrical resistance inside a fuel cell for different clamping pressures.

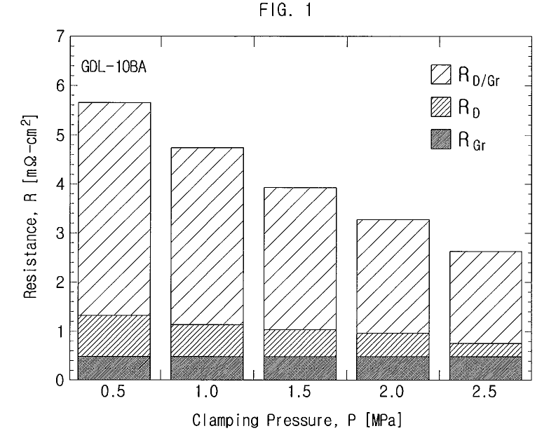

FIG. 2 is a cross-sectional view of a current collector in accordance with an aspect of the present invention.

FIG. 3 is a cross-sectional view of an embodiment of a fuel cell stack in accordance with another aspect of the present invention.

FIG. 4 is a cross-sectional view of another embodiment of a fuel cell stack in accordance with another aspect of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A current collector and a fuel cell stack in accordance with certain embodiments of the present invention will be described below in more detail with reference to the accompanying drawings. Those components that are the same or are in correspondence are rendered the same reference numeral regardless of the figure number, and redundant explanations are omitted.

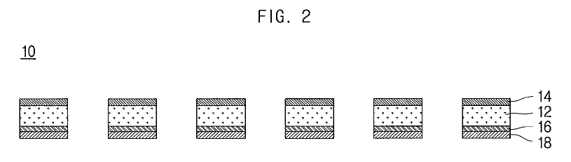

FIG. 2 is a cross-sectional view of a current collector 10 in accordance with an aspect of the present invention. Illustrated in FIG. 2 are a substrate 12, a double-side adhesive layer 14, a collecting pattern 16 and a conductive adhesive layer 18.

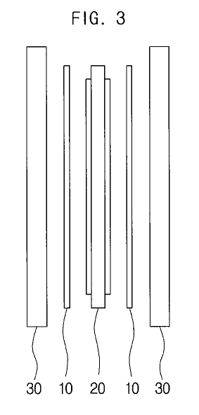

If a flexible film made of a flexible material such as polyimide is used for the substrate, which is a base layer of the current collector 10, a thin flexible fuel cell stacking structure can be implemented. Since the substrate is positioned on either surface of a membrane electrode assembly (MEA, 20 in FIG. 3), an aperture, through which fuel and air being supplied to the membrane electrode assembly can pass, can be formed on the substrate. The shape of the aperture can be in various shapes, such as a serpentine shape or an eddy shape, such that gas can be evenly supplied to the membrane electrode assembly (MEA, 20 in FIG. 3).

The role of the double-side adhesive layer 14 formed on the other side of the substrate is to enhance adhesion between the current collector 10 and the end plate (30 in FIG. 3) because it has adhesion strength not only on a surface being in contact with the current collector 10 but also on an opposite surface of the surface being in contact with the current collector 10. By increasing the adhesive strength with the end plate, the clamping pressure can be increased without increasing the thickness of the end plate. As described above, the electrical resistance decreases as the clamping pressure increases so that the performance of the current collector improves.

The collecting pattern 16 is interposed between the current collector 10 and the membrane electrode assembly (MEA, 20 in FIG. 3) and where the current collector 10 and the membrane electrode assembly are in contact. The collecting pattern 16 is a part that virtually collects the electric current, and thus it is preferred that a highly electrical conductive material, for example, a material including at least one of copper (Cu), nickel (Ni), gold (Au) and platinum (Pt), is used. Considering the cost, copper (Cu) and nickel (Ni) are preferred, but they are more corrosive. One solution to this problem is that copper (Cu) and nickel (Ni) are used to form the collecting pattern but are plated with gold (Au) or platinum (Pt), which are very durable against corrosion. The collecting pattern 16 can be shaped variously in accordance with the shape of the aperture of the substrate. The larger the collecting area, the more the electric current can be collected, thereby improving the collecting efficiency. Thus, the pattern can be designed in a shape of an appropriate pattern in accordance with the relationship between the gas input/output and the area of the collecting pattern 14.

It is preferable that an adhesive layer is also formed on a surface being in contact with the membrane electrode assembly (20 in FIG. 3) because the stack performs better as the contact between the membrane electrode assembly (20 in FIG. 3) and the collecting pattern 16 is tighter. To do this, the conductive adhesive layer 18 having conductive properties as well as providing adhesion strength can be formed on the collecting pattern 16. To prevent a reduction in collecting performance due to the adhesive layer, a conductive substance such as metal particles and carbon nanotubes can be injected into the conductive adhesive layer 18.

The current collector 10 having the stacking structure described above can be excellent in collecting performance by increasing the adhesion between the end plate (30 in FIG. 3) and the membrane electrode assembly (20 in FIG. 3) and reducing the electrical resistance.

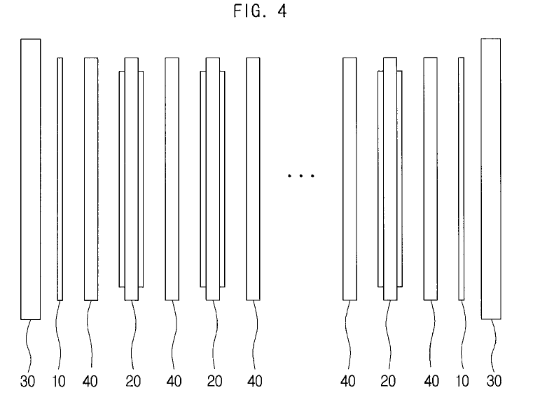

Below, the structure of the stack using the current collector 10 described above will be described with reference to FIGS. 3 and 4.

FIG. 3 is a cross-sectional view of an embodiment of a fuel cell stack in accordance with another aspect of the present invention. Illustrated in FIG. 3 are the current collector 10, a membrane electrode assembly 20 and an end plate 30. These are basic components of the stack, in which the membrane electrode assembly 20 is disposed between a pair of end plates and the current collector 10 is disposed between the membrane electrode assembly 20 and the end plate 30. The membrane electrode assembly 20 is constituted by a fuel electrode and an air electrode formed on either side of the electrolyte layer. Hydrogen is supplied to the fuel electrode, and oxygen is supplied to the air electrode. Energy is obtained by reacting hydrogen with a catalyst.

The reaction at each electrode can be represented in case a direct methanol fuel cell (DMFC) is used.

Fuel electrode: CH₃OH+H₂O→CO₂+6H⁺+6e [Reaction Scheme 1]

Air electrode: (3/2)O₂+6H⁺+6e⁻→3H₂O [Reaction Scheme 2]

Overall Reaction: CH₃OH+(3/2)O₂→2H₂O+CO₂ [Reaction Scheme 3]

Electricity is generated through the reactions described above, and water is generated at the air electrode. As described above, the reactions described above occur in the case of the direct methanol fuel cell (DMFC), and thus it shall be apparent that the reaction at each electrode can be varied in accordance with the type of fuel cell.

The end plate 30, which is positioned at the outermost edge of the stacking structure, makes the stacking structure secure. Although the end plate 30 enhances the performance when it is thicker, it also makes the stacking structure adversely thicker. In general, the stacking structure is completed by fastening a pair of the end plates 30 with bolts and nuts.

FIG. 4 is a cross-sectional view of another embodiment of the fuel cell stack in accordance with another aspect of the present invention. Illustrated in FIG. 4 are the current collector 10, the membrane electrode assembly 20, the end plate 30 and a bipolar plate 40.

In the present embodiment, a plurality of membrane electrode assemblies 20 are included in the stacking structure illustrated in FIG. 3. This stacking structure can include the bipolar plate 40, which is interposed between the adjacent membrane electrode assemblies 20 to face one another and operates to supply hydrogen and oxygen to the fuel electrode and the air electrode, respectively.

The fuel cell stack that uses the current collector 10 with an adhesive layer formed on both surfaces thereof has been described. While using the fuel cell stack described above, the electrical resistance inside the fuel cell can be reduced, thus improving the performance of the fuel cell. Moreover, even if the end plate is made thinner, the clamping pressure required in the fuel cell can be provided.

While the spirit of the invention has been described in detail with reference to certain embodiments, the embodiments are for illustrative purposes only and shall not limit the invention. It is to be appreciated that those skilled in the art can change or modify the embodiments without departing from the scope and spirit of the invention. As such, many embodiments other than those set forth above can be found in the appended claims.

What is claimed is:

1. A current collector comprising:
a substrate;
a double-side adhesive layer formed on one surface of the substrate;
a collecting pattern formed on the other surface of the substrate; and
a conductive adhesive layer formed on the collecting pattern.

2. The current collector of claim 1, wherein an aperture through which gas can pass is formed on the substrate.

3. The current collector of claim 1, wherein the collecting pattern is made of a material comprising at least one selected from a group consisting of copper (Cu), nickel (Ni), gold (Au) and platinum (Pt).

4. The current collector of claim 1, wherein the substrate is a flexible film.

5. A fuel cell stack comprising:
a pair of end plates;
a current collector, one surface of the current collector being in contact with an inner side of the pair of end plates; and
a membrane electrode assembly (MBA) being interposed between the current collectors and including an electrolyte layer, an air electrode and a fuel electrode, the air electrode and the fuel electrode being coupled to either surface of the electrolyte layer,
wherein the current collector comprises:
a substrate;
a double-side adhesive layer formed on one surface of the substrate and being in contact with the end plate;
a collecting pattern formed on the other surface of the substrate; and
a conductive adhesive layer formed on the collecting pattern and being in contact with the membrane electrode assembly.

6. The fuel cell stack of claim 5, wherein an aperture through which gas can pass is formed on the substrate.

7. The fuel cell stack of claim 5, wherein the collecting pattern is made of a material comprising at least one selected from a group consisting of copper (Cu), nickel (Ni), gold (Au) and platinum (Pt).

8. The fuel cell stack of claim 5, wherein the substrate is a flexible film.

9. The fuel cell stack of claim 5, wherein there are a plurality of membrane electrode assemblies, and a bipolar plate is interposed between the plurality of membrane electrode assemblies.
